(19) United States
(12) Patent Application Publication
(10) Pub. No.: US 2016/0044432 A1
(43) Pub. Date: Feb. 11, 2016

(54) AUDIO SIGNAL PROCESSING APPARATUS

(71) Applicant: Huawei Technologies Co., Ltd., Shenzhen (CN)

(72) Inventors: Peter Grosche, Munich (DE); David Virette, Munich (DE)

(21) Appl. No.: 14/921,588

(22) Filed: Oct. 23, 2015

Related U.S. Application Data
(63) Continuation of application No. PCT/EP2013/059039, filed on Apr. 30, 2013.

(51) Int. Cl. H04S 1/00; H04S 7/00

(52) U.S. Cl. CPC H04S 1/005; H04S 7/308; H04S 2420/03; H04S 2420/01

(57) ABSTRACT

The invention relates to an audio signal processing apparatus for processing an audio signal, the audio signal processing apparatus comprising: a converter configured to convert a stereo audio signal into a binaural audio signal; and a determiner configured to determine upon the basis of an indicator signal whether the audio signal is a stereo audio signal or a binaural audio signal, the indicator signal indicating whether the audio signal is a stereo audio signal or a binaural audio signal, the determiner being further configured to provide the audio signal to the converter if the audio signal is a stereo audio signal.

### CROSS-REFERENCE TO RELATED APPLICATIONS

This application is a continuation of International Application No. PCT/EP2013/059039, filed on Apr. 30, 2013, which is hereby incorporated by reference in its entirety.

### TECHNICAL FIELD

The present invention relates to the field of audio signal processing.

### BACKGROUND

Audio signals can be divided into two different categories as described e.g. in Pekonen, J.; Microphone Techniques for Spatial Sound, Audio Signal Processing Seminar, TKK Helsinki University, 2008. The first category comprises stereo audio signals as e.g. recorded by conventional microphones. The second category comprises binaural audio signals as e.g. recorded using a dummy head.

Stereo audio signals are designed for a stereophonic presentation using two loudspeakers in front of a listener with the goal to create a perception of locations of sound sources at positions which are different from the positions of the loudspeakers. These sound sources are also denoted as phantom sources. A presentation of stereo audio signals using headphones is also possible. The placement of a sound source in space is achieved by changing the intensity and/or properly delaying the source signals given to the left and the right loudspeaker and/or headphone which is denoted as amplitude or intensity panning or delay panning. Stereo recordings using two microphones in a proper configuration, e.g. A-B or X-Y can also create a sense of source location.

Stereo audio signals are not able to create the impression of a source outside of the line segment between the two loudspeakers and result in an in-head localization of sound sources when listening via headphones. The position of the phantom sources is limited and the listening experience is not immersive.

Binaural audio recordings, however, capture the sound pressures at both ear drums of a listener as they are occurring in a real acoustic scene as described e.g. in Blauert, J.; Braasch, J., Binaural Signal Processing, IEEE DSP, 2011. When presenting a binaural audio signal to a listener, a copy of the signals at the eardrums of the listener is produced as it would have been experienced at the recording location. Binaural cues, e.g. interaural-time- and/or level-differences, which are captured in the two audio signals, enable an immersive listening experience where sound sources can be positioned all around the listener.

For the presentation of binaural audio signals to the listener, it is desirable to ensure that each channel is presented independently without any crosstalk. Crosstalk refers to the undesired case that a part of the signal which is recorded at the right ear drum of the listener is presented to the left ear, and vice versa. Preventing crosstalk is naturally achieved when presenting binaural audio signals using conventional headphones. Presentation using conventional stereo loudspeakers requires a means to actively cancel the undesired crosstalk using a suitable processing which avoids that a signal produced by the left speaker reaches the right eardrum, and vice versa. Crosstalk cancellation can be achieved using filter inversion techniques. Such enriched speakers are also denoted as crosstalk-cancelled loudspeaker pairs. Binaural audio signals presented without crosstalk can provide a fully immersive listening experience, where the positions of sound sources are not limited but basically span the entire 3-dimensional space around the listener.

For obtaining binaural audio signals, which create a fully immersive listening experience, it is desirable to capture the signal at the eardrums of the listener. Although specially designed microphones exist which can be worn by the listener, most binaural audio signals are obtained using a dummy head. A dummy head is an artificial head which mimics the acoustic properties of a real human head and has two microphones embedded at the position of the eardrums.

For stereo audio signals, methods exist which increase the width of the acoustic scene. Such methods are well-known and widely used under the name of stereo widening or sound externalization, as described e.g. in Floros, A.; Tatlas, N. A.; Spatial enhancement for immersive stereo audio applications, IEEE-DSP 2011. The main strategy is to introduce synthetic binaural cues and superimpose them to stereo audio signals which allows for positioning sound sources outside of the line-segment between the loudspeakers or headphones.

As a result, the width of a virtual sound stage can be increased beyond the typical loudspeaker span of ±30° and a more natural out-of-head experience can be achieved using headphones as described e.g. in Liitola, T.; Headphone Sound Externalization, PhD Thesis Helsinki University, 2006. Presentation of the resulting signals usually requires a means to prevent crosstalk, e.g. using headphones or a crosstalk-cancelled loudspeaker pair.

The application of stereo widening methods is only desirable for stereo audio signals that do not contain binaural cues. For binaural recordings, introducing additional synthetic binaural cues with the goal to widen the stereo image results in binaural cues which conflict with the natural cues already contained in the binaural signal. As a result of such conflicting cues, the human auditory system is not able to resolve the positions of the sources and any perception of a 3-dimensional sound scene is destroyed.

In existing methods, the decision whether stereo widening should be applied to enhance the perception is done manually by the listener. The listener has to decide whether to turn on stereo widening or not.

In typical listening scenarios which feature stereo widening methods such as smartphones, MP3 players, or PC soundcards, the stereo widening is therefore usually applied by default. In order to obtain the best possible listening experience using current technology, the listener would have to disable the stereo widening in the settings of the device. This requires that the listener is aware of the fact that he is listening to a binaural audio signal, that his device is using a stereo widening method, and that the stereo widening should be deactivated for binaural audio signals. As a result, a listener usually experiences a reduced 3-dimensional listening experience when listening to binaural audio signals.

### SUMMARY

It is an object of the invention to provide an improved solution for creating an immersive listening experience for any kind of audio signal, i.e. for stereo audio signals and binaural audio signals without requiring any kind of manual intervention by the listener.

This object is achieved by the features of the independent claims. Further implementation forms are apparent from the dependent claims, the description and the figures.

According to a first aspect, the invention relates to an audio signal processing apparatus for processing an audio signal, the audio signal processing apparatus comprising: a converter configured to convert a stereo audio signal into a binaural audio signal; and a determiner configured to determine upon the basis of an indicator signal whether the audio signal is a stereo audio signal or a binaural audio signal, the indicator signal indicating whether the audio signal is a stereo audio signal or a binaural audio signal, the determiner being further configured to provide the audio signal to the converter if the audio signal is a stereo audio signal.

Thus, the audio signal processing apparatus allows for providing an immersive listening experience for any kind of audio signal without requiring any kind of manual intervention by a listener.

Thus, the stereo audio signals are processed using, for example, a stereo widening technique based on synthetic binaural cues to increase the width of the acoustic scene and create an out-of-head experience. Binaural audio signals, however, are presented unmodified in order to recreate the original recorded 3-dimensional scene.

The audio signal can be a stereo audio signal or a binaural audio signal. A stereo audio signal can have been recorded e.g. by conventional stereo microphones. A binaural audio signal can have been recorded e.g. by microphones on a dummy head.

The audio signal can further be provided as a two-channel audio signal or a parametric audio signal. A two-channel audio signal can comprise a first audio channel signal, e.g. a left channel, and a second audio channel signal, e.g. a right channel. A parametric audio signal can comprise a down-mix audio signal and parametric side information. The down-mix audio signal can be obtained by down-mixing a two-channel audio signal to a single or mono audio channel. The parametric side information can correspond to the down-mix audio signal and can comprise localization cues or spatial cues.

The audio signal can therefore be provided by one of four different combinations. The audio signal can be a two-channel stereo audio signal, a two-channel binaural audio signal, a parametric stereo audio signal, or a parametric binaural audio signal.

The converter can be configured to convert a stereo audio signal into a binaural audio signal. For this purpose, stereo widening techniques and/or sound externalization techniques can be applied, which can add synthetic binaural cues to the stereo audio signal.

The determiner can be configured to determine upon the basis of an indicator signal whether the audio signal is a stereo audio signal or a binaural audio signal. The determiner can further be configured to provide the audio signal to the converter if the audio signal is a stereo audio signal. For this purpose, the determiner can e.g. compare a value provided by the indicator signal, e.g. 0.6, with a predefined threshold value, e.g. 0.4, and determine that the audio signal is a stereo audio signal if the value is less than the predefined threshold value and that the audio signal is a binaural audio signal if the value is greater than the predefined threshold value, or vice versa. Alternatively, the determiner can e.g. determine that the audio signal is a stereo audio signal or binaural audio signal based on a flag provided by the indicator signal.

The converter and the determiner can be implemented on a processor.

The indicator signal can indicate whether the audio signal is a stereo audio signal or a binaural audio signal. The indicator signal can provide a value, e.g. a numerical value, or a flag for indicating whether the audio signal is a stereo audio signal or a binaural audio signal to the determiner.

In a first implementation form according to the first aspect, the audio signal processing apparatus comprises an output terminal for outputting the binaural audio signal, wherein the determiner is configured to directly provide the audio signal to the output terminal if the audio signal is a binaural audio signal.

Thus, the binaural audio signal is not provided to the converter and therefore, no synthetic binaural cues are added to the binaural signal. This way, the original binaural acoustic scene of the binaural audio signal is preserved and an immersive listening experience is achieved.

The output terminal can be configured for a stereo audio signal and/or a binaural audio signal. The output terminal can further be configured for a two-channel audio signal and/or a parametric audio signal. Therefore, the output terminal can be configured for a two-channel stereo audio signal, a two-channel binaural audio signal, a parametric stereo audio signal, a parametric binaural audio signal, or combinations thereof.

In a second implementation form according to the first aspect as such or according to the first implementation form of the first aspect, the audio signal processing apparatus further comprises an analyzer for analyzing the audio signal to generate the indicator signal.

Thus, the apparatus can be employed for any conventional audio signal without external provision of the indicator signal.

The analyzer can be configured to analyze the audio signal to generate the indicator signal indicating whether the audio signal is a stereo audio signal or a binaural audio signal. The analyzer can further be configured to extract localization cues from the audio signal, the localization cues indicating a location of an audio source, and to analyze the localization cues in order to generate the indicator signal.

The analyzer can be implemented on a processor.

In a third implementation form according to the second implementation form of the first aspect, the analyzer is configured to extract localization cues from the audio signal, the localization cues indicating a location of an audio source, and to analyze the localization cues in order to generate the indicator signal.

Thus, profound criteria for the immersiveness of the audio signal can be analyzed in order to generate a reliable and representative indicator signal.

The localization cues or spatial cues can comprise information about the spatial arrangement of one or several audio sources in the audio signal. The localization cues or spatial cues can comprise e.g. interaural-time-differences (ITD), interaural-phase-differences (IPD), interaural-level-differences (ILD), direction selective frequency filtering of the outer ear, direction selective reflections at the head, shoulders and body, and/or environmental cues. Interaural-level-differences, interaural-coherence differences, interaural-phase-differences and interaural-time-differences are represented as interchannel-level-differences, interchannel-channel differences, interchannel-phase-differences and interchannel-time-differences in the recorded audio signals. The term “localization cues” and the term “spatial cues” can be used equivalently.

The audio source can be characterized as a source of an acoustic wave recorded by microphones. The source of the acoustic wave can e.g. be a musical instrument or a person speaking.

The location of the audio source can be characterized by an angle, e.g. 25°, relative to a central axis of the audio recording setup. The central axis can e.g. be characterized by 0°. The left direction and right direction can e.g. be characterized by +90° and −90°. The location of the audio source within the audio recording setup, e.g. the spatial audio recording setup, can thus be represented e.g. as an angle with regard to the central axis.

The extraction of the localization cues can comprise the application of further audio signal processing techniques. The extraction can be performed in a frequency selective manner using sub-band decomposition as a preprocessing step.

The analysis of the localization cues can comprise an analysis of positions of audio sources in the audio signal. Furthermore, the analysis of the localization cues can comprise an analysis of consistency, such as left/right consistency, inter-cue consistency, and/or consistency with a model of perception. Moreover, the analysis of the localization cues can comprise an analysis of further criteria, such as—coherence and/or cross-correlation.

The analysis of the localization cues can further comprise a determination of an immersiveness of the audio signal by using and/or combining the aforementioned criteria such as the positions of audio sources, the consistency, and the further criteria in order to obtain an immersiveness measure.

The generation of the indicator signal can be based on the analysis of the localization cues and/or the determination of the immersiveness of the audio signal. Furthermore, the generation of the indicator signal can be based on the obtained immersiveness measure. The generation of the indicator signal can yield a value, e.g. a numerical value, or a flag for indicating whether the audio signal is a stereo audio signal or a binaural audio signal.

In a fourth implementation form according to the first aspect as such or according to any of the preceding implementation forms of the first aspect, the converter is configured to add synthetic binaural cues to the stereo audio signal to obtain the binaural audio signal.

Thus, the stereo audio signal can be converted to the binaural audio signal providing an immersive listening experience.

The converter can therefor apply stereo widening techniques and/or sound externalization techniques, which can widen the perception of the acoustic scene.

The synthetic binaural cues can relate to binaural cues, which are not present in the audio signal and are generated synthetically on the basis of an audio perception model. The binaural cues can be characterized as localization cues or spatial cues.

In a fifth implementation form according to the first aspect as such or according to any of the preceding implementation forms of the first aspect, the audio signal is a two-channel audio signal comprising a first audio channel signal and a second audio channel signal, wherein the analyzer is configured to determine an immersiveness measure based on an interchannel-coherence or an interchannel-time-difference or an interchannel-level-difference or combinations thereof between the first audio channel signal and the second audio channel signal, and to analyze the immersiveness measure to generate the indicator signal.

Thus, the immersiveness measure can be based on profound criteria for the immersiveness of the audio signal and a reliable and representative indicator signal can be generated.

The first audio channel signal can relate to a left audio channel signal. The second audio channel signal can relate to a right audio channel signal.

The interchannel-coherence can describe a degree of similarity, e.g. an amount of correlation, of the audio channel signals with a value between 0 and 1. Lower values of the interchannel-coherence can indicate a large perceived width of the audio signal. A large perceived width of the audio signal can indicate a binaural audio signal.

The interchannel-time-difference can relate to a relative time delay or relative time difference between the occurrence of a sound source in the first audio channel signal and the second audio channel signal. The interchannel-time-difference can be used to determine a direction or angle of the sound source.

The interchannel-level-difference can relate to a relative level difference or relative attenuation between the acoustic power level of a sound source in the first audio channel signal and the second audio channel signal. The interchannel-level-difference can be used to determine a direction or angle of the sound source.

The immersiveness measure can be based on the interchannel-coherence or the interchannel-time-difference or the interchannel-phase difference or the interchannel-level-difference or combinations thereof. The immersiveness measure can relate to a degree of similarity of the audio channel signals, positions of audio sources in the audio channel signals and/or a consistency of localization cues in the audio channel signals.

In a sixth implementation form according to the first aspect as such or according to any of the preceding implementation forms of the first aspect, the audio signal is a two-channel audio signal comprising a first audio channel signal and a second audio channel signal, wherein the analyzer is configured to determine a number of first original signals for the first audio channel signal and a number of second original signals for the second audio channel signal by means of inverse filtering by a number of head-related-transfer-function pairs and to analyze the number of first original signals and the number of second original signals to generate the indicator signal.

Thus, another profound criterion for the immersiveness of the audio signal can be evaluated and a reliable and representative indicator signal can be generated.

The first audio channel signal can relate to a left audio channel signal. The second audio channel signal can relate to a right audio channel signal.

The number of first original signals can relate to the original audio signal originating from the audio source. The number of first original signals can be supposed to have been filtered by a number of first head-related-transfer-functions.

The number of second original signals can relate to the original audio signal originating from the audio source. The number of second original signals can be supposed to have been filtered by a number of second head-related-transfer-functions.

By inverse filtering the first audio channel signal and the second audio channel signal by the number of head-related-transfer-function pairs, the number of first original signals and the number of second original signals can be obtained and evaluated.

The inverse filtering can comprise the determination of an inverse filter e.g. by minimum-mean-square-error (MMSE) methods and the application of the inverse filter on the audio signals.

Each head-related-transfer-function pair can correspond to a given audio source angle. The head-related-transfer-functions can be characterized in time domain, e.g. as impulse responses, and/or in frequency domain, e.g. as frequency responses. The head-related-transfer-functions can represent the entire set of localization cues for a given source angle.

The analysis of the number of first original signals and the number of second original signals can comprise a correlation of each pair of first original signals and second original signals and a determination of the pair yielding a maximum correlation value. The determined pair can correspond to the angle of the audio source. The maximum correlation value can indicate a degree of consistency of the localization cues and provide a measure for the immersiveness of the audio signal.

In a seventh implementation form according to the first aspect as such or according to any of the preceding implementation forms of the first aspect, the audio signal is a parametric audio signal comprising a down-mix audio signal and parametric side information, wherein the analyzer is configured to extract and analyze the parametric side information to generate the indicator signal.

Thus, an efficient analysis of the parametric audio signal and an efficient generation of the indicator signal can be achieved.

The parametric audio signal can comprise a down-mix audio signal and parametric side information.

The down-mix audio signal can be obtained by down-mixing a two-channel audio signal to a single audio channel.

The parametric side information can correspond to the down-mix audio signal and can comprise localization cues or spatial cues.

The parametric side information can be further processed to determine whether the audio signal is a stereo audio signal or a binaural audio signal.

The extraction of the parametric side information from the parametric audio signal can comprise selecting or rejecting a part of the parametric audio signal.

The analysis of the parametric side information can comprise a conversion of the localization cues or spatial cues present in the parametric audio signal into a different format.

In an eighth implementation form according to the first aspect as such or according to any of the preceding implementation forms of the first aspect, the determiner is configured to determine that the audio signal is a stereo audio signal if the indicator signal comprises a first signal value and/or to determine that the audio signal is a binaural audio signal if the indicator signal comprises a second signal value.

Thus, an efficient way of representing whether the audio signal is a stereo audio signal or a binaural audio signal can be employed.

The first signal value can comprise a numerical value, e.g. 0.4, or a binary value, e.g. 0 or 1. Furthermore, the first signal value can comprise a flag indicating whether the audio signal is a stereo audio signal or a binaural audio signal.

The second signal value, which is different to the first signal value, can comprise a numerical value, e.g. 0.6, or a binary value, e.g. 1 or 0. Furthermore, the second signal value can comprise a flag indicating whether the audio signal is a stereo audio signal or a binaural audio signal.

In a ninth implementation form according to the first aspect as such or according to any of the preceding implementation forms of the first aspect, the indicator signal is a part of the audio signal and the determiner is configured to extract the indicator signal from the audio signal.

Thus, an internal generation of the indicator signal can be avoided and a simplified use of the audio signal processing apparatus can be realized.

The part of the audio signal and/or the audio signal as such can be provided as a bit-stream. The bit-stream can comprise a digital representation of the audio signal and can be encoded by an audio coding scheme, such as e.g. pulse-code modulation (PCM). The bit-stream can further comprise metadata in a metadata container format, such as ID3v1, ID3v2, APEv1, APEv2, CD-Text, or Vorbis comment.

The extraction of the indicator signal from the audio signal can comprise selecting or rejecting a part of the audio signal and/or bit-stream.

According to a second aspect, the invention relates to an analyzer for analyzing an audio signal to generate an indicator signal indicating whether the audio signal is a stereo audio signal or a binaural audio signal, wherein the analyzer is configured to extract localization cues from the audio signal, the localization cues indicating a location of an audio source, and to analyze the localization cues in order to generate the indicator signal.

Thus, the analysis of the audio signal and generation of the indicator signal can be performed independently.

The analyzer can be implemented on a processor.

The localization cues or spatial cues can comprise information about the spatial arrangement of one or several audio sources in the audio signal. The localization cues or spatial cues can comprise e.g. interaural-time-differences (ITD), interaural-level-differences (ILD), direction selective frequency filtering of the outer ear, direction selective reflections at the head, shoulders and body, and/or environmental cues. Interaural-level- and interaural-time-differences are represented as interchannel-level- and interchannel-time-differences in the recorded audio signals. The term “localization cues” and the term “spatial cues” can be used equivalently.

The audio source can be characterized as a source of an acoustic wave recorded by microphones. The source of the acoustic wave can e.g. be a musical instrument.

The location of the audio source can be characterized by an angle, e.g. 25°, relative to a central axis of the audio recording setup. The central axis can e.g. be characterized by 0°. The left direction and right direction can e.g. be characterized by +90° and −90°. The location of the audio source within the audio recording setup, e.g. the spatial audio recording setup, can thus be represented e.g. as an angle with regard to the central axis.

The extraction of the localization cues can comprise the application of further audio signal processing techniques. The extraction can be performed in a frequency selective manner using sub-band decomposition as a preprocessing step.

The analysis of the localization cues can comprise an analysis of positions of audio sources in the audio signal. Furthermore, the analysis of the localization cues can comprise an analysis of consistency, such as left/right consistency, inter-cue consistency, and/or consistency with a model of perception. Moreover, the analysis of the localization cues can comprise an analysis of further criteria, such as interchannel-coherence and/or cross-correlation.

The analysis of the localization cues can further comprise a determination of an immersiveness of the audio signal by using and/or combining the aforementioned criteria such as the positions of audio sources, the consistency, and the further criteria in order to obtain an immersiveness measure.

The generation of the indicator signal can be based on the analysis of the localization cues and/or the determination of the immersiveness of the audio signal. Furthermore, the generation of the indicator signal can be based on the obtained immersiveness measure. The generation of the indicator signal can yield a value, e.g. a numerical value, or a flag for indicating whether the audio signal is a stereo audio signal or a binaural audio signal.

According to a third aspect, the invention relates to a method for processing an audio signal, the method comprising: determining upon the basis of an indicator signal whether the audio signal is a stereo audio signal or a binaural audio signal, the indicator signal indicating whether the audio signal is a stereo audio signal or a binaural audio signal; and converting the stereo audio signal into a binaural audio signal if the audio signal is a stereo audio signal.

Thus, the method for processing the audio signal can allow for providing an immersive listening experience for any kind of audio signal without requiring any kind of manual intervention by a listener.

The method for processing the audio signal can be implemented by the audio signal processing apparatus according to the first aspect of the invention.

Further features of the method for processing the audio signal can result from the functionality of the audio signal processing apparatus according to the first aspect of the invention.

In a first implementation form according to the third aspect, the method further comprises extracting the indicator signal from the audio signal.

Thus, an internal generation of the indicator signal can be avoided and a simplified use of the method for processing the audio signal can be realized.

The audio signal can be provided as a bit-stream. The bit-stream can comprise a digital representation of the audio signal and can be encoded by an audio coding scheme, such as e.g. pulse-code modulation (PCM). The bit-stream can further comprise metadata in a metadata container format, such as ID3v1, ID3v2, APEv1, APEv2, CD-Text, or Vorbis comment.

The extraction of the indicator signal from the audio signal can comprise selecting or rejecting a part of the audio signal and/or bit-stream.

According to a fourth aspect, the invention relates to a method for analyzing the audio signal to generate an indicator signal indicating whether the audio signal is a stereo audio signal or a binaural audio signal, the method comprising: extracting localization cues from the audio signal, the localization cues indicating a location of an audio source; and analyzing the localization cues in order to generate the indicator signal.

Thus, the analysis of the audio signal and generation of the indicator signal can be performed independently.

The method for analyzing the audio signal can be implemented by the analyzer according to the second aspect of the invention.

Further features of the method for analyzing the audio signal can result from the functionality of the analyzer according to the second aspect of the invention.

According to a fifth aspect, the invention relates to an audio signal processing system, comprising: the audio signal processing apparatus of the first aspect as such or of any of the preceding implementation forms of the first aspect; and the analyzer for analyzing the audio signal to generate an indicator signal according to the second aspect.

The audio signal processing apparatus and the analyzer can be operated at different times and/or different locations.

According to a sixth aspect, the invention relates to computer program for performing the method of the third aspect as such, the method of the first implementation form of the third aspect, or the method of the fourth aspect as such when executed on a computer.

Thus, the methods can be applied in an automatic and repeatable manner.

The computer program can be provided in form of a machine-readable code. The computer program can comprise a series of commands for a processor of the computer. The processor of the computer can be configured to execute the computer program.

The computer can comprise a processor, a memory, and/or input/output means.

The computer program can be configured to perform the method of the third aspect as such, the method of the first implementation form of the third aspect, and/or the method of the fourth aspect as such.

Further features of the computer program can result from the functionality of the method of the third aspect as such, the method of the first implementation form of the third aspect, and/or the method of the fourth aspect as such.

According to a seventh aspect, the invention relates to a programmably arranged audio signal processing apparatus being configured to execute the computer program for performing the method of the third aspect as such, the method of the first implementation form of the third aspect, or the method of the fourth aspect as such.

According to an eighth aspect, the invention relates to an audio signal processing apparatus for processing an audio signal, the audio signal processing apparatus being configured to convert a stereo audio signal into a binaural audio signal and to determine upon the basis of an indicator signal whether the audio signal is a stereo audio signal or a binaural audio signal, the indicator signal indicating whether the audio signal is a stereo audio signal or a binaural audio signal, and to convert the audio signal if the audio signal is a stereo audio signal.

The invention can be implemented in hardware and/or software.

### BRIEF DESCRIPTION OF THE DRAWINGS

Further embodiments of the invention will be described with respect to the following figures, in which:

FIG. 1 shows a schematic stereo signal presentation to a listener using two loudspeakers or headphones;

FIG. 2 shows a schematic binaural signal presentation to a listener using headphones or a crosstalk-cancelled loudspeaker pair;

FIG. 3 shows a schematic audio signal presentation to a listener using a crosstalk-cancelled loudspeaker pair or headphones for stereo widened audio signals;

FIG. 4 shows a schematic diagram of an audio signal processing apparatus according to an embodiment of the invention;

FIG. 5 shows a schematic diagram of an analyzer for a two-channel input audio signal according to an embodiment of the invention;

FIG. 6 shows a schematic diagram of an analyzer for a parametric input audio signal according to an embodiment of the invention;

FIG. 7 shows a schematic diagram of an analyzing method according to an embodiment of the invention;

FIG. 8 shows a schematic diagram of an audio signal processing system according to an embodiment of the invention;

FIG. 9 shows a schematic diagram of a method for processing an audio signal according to an embodiment of the invention; and

FIG. 10 shows a schematic diagram of a method for analyzing an audio signal according to an embodiment of the invention.

Equal or equivalent elements are denoted in the following description of the figures by equal or equivalent reference signs.

### DETAILED DESCRIPTION

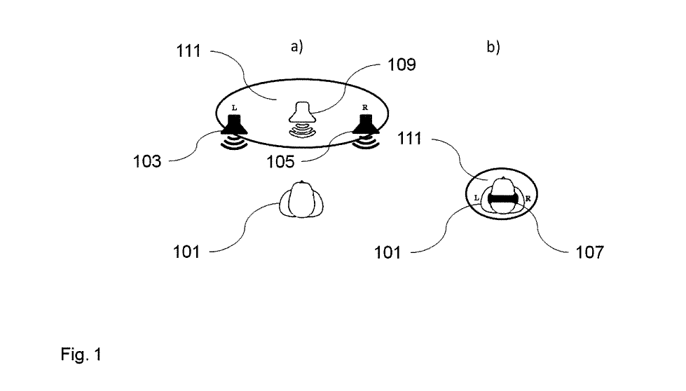

FIG. 1 shows a schematic stereo signal presentation to a listener 101 using two loudspeakers 103, 105 or headphones 107. The stereo signal presentation to the listener 101 using two loudspeakers 103, 105 is depicted in FIG. 1a and the stereo signal presentation to the listener 101 using headphones 107 is depicted in FIG. 1b. The left loudspeaker 103 and the left audio channel output by the left loudspeaker 103 are also denoted as “L” and the right loudspeaker 105 and the right audio channel are also denoted as “R”.

An exemplary phantom source 109 is depicted in FIG. 1a between the left loudspeaker 103 and the right loudspeaker 105. The possible positions 111 of phantom sources 109, as indicated in a schematic way, are limited to the line segment between the two loudspeakers 103, 105 or headphones 107.

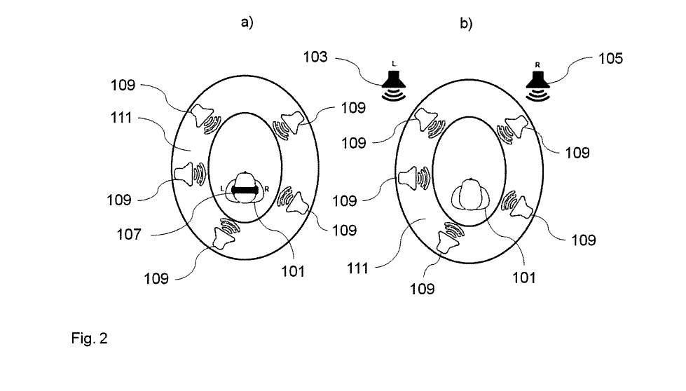

FIG. 2 shows a schematic binaural signal presentation to a listener 101 using headphones 107 or a crosstalk-cancelled loudspeaker pair 103, 105. The binaural signal presentation to the listener 101 using headphones 107 is depicted in FIG. 2a and the binaural signal presentation to the listener 101 using the crosstalk-cancelled loudspeaker pair 103, 105 is depicted in FIG. 2b. The left loudspeaker 103, the left loudspeaker of the headphone 107 and the left audio channel output by the left loudspeaker 103 are also denoted as and the right loudspeaker 105, the right loudspeaker of the headphone 107 and the right audio channel are also denoted as “R”.

A number of exemplary phantom sources 109 is depicted around the listener 101 in FIG. 2a and FIG. 2b. The possible positions 111 of phantom sources 109, as indicated in a schematic way, surround the listener 101 and allow to create a fully immersive 3D listening experience.

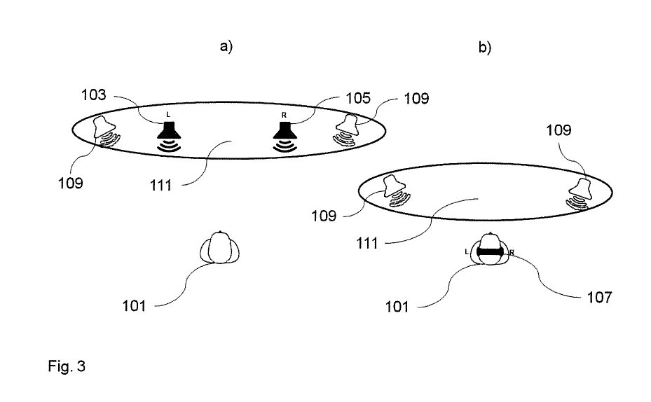

FIG. 3 shows a schematic audio signal presentation to a listener 101 using a crosstalk-cancelled loudspeaker pair 103, 105 or headphones 107 for stereo widened audio signals. The presentation of the signal to the listener 101 using a crosstalk-cancelled loudspeaker pair 103, 105 is depicted in FIG. 3a and the presentation of the signal to the listener 101 using headphones 107 is depicted in FIG. 3b. The left loudspeaker 103 and the left audio channel output by the left loudspeaker 103 are also denoted as and the right loudspeaker 105 and the right audio channel are also denoted as “R”.

The widening of the stereo audio signals, as depicted in FIG. 3 by depicting exemplary phantom sources 109 outside of the space or line-segment between the left physical loudspeaker 103 and the right physical loudspeaker 105, can be achieved by introducing synthetic binaural cues into the stereo audio signals.

A number of exemplary phantom sources 109 is depicted in front of the listener 101. The positions of the phantom sources 111 are no longer limited to the line-segment between the left loudspeaker 103 and the right loudspeaker 105 (see FIG. 3a compared FIG. 1a), nor to in-head positions in case of headphones 107 (see FIG. 3b compared to FIG. 1b). The 3D listening experience is enhanced.

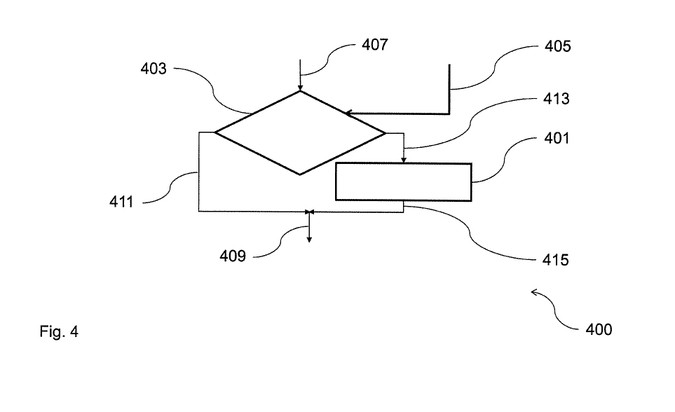

FIG. 4 shows a schematic diagram of an audio signal processing apparatus 400. The audio signal processing apparatus 400 comprises a converter 401 and a determiner 403. An indicator signal 405 and an input audio signal 407 are provided to the determiner 403. An output audio signal 409 is provided by the audio signal processing apparatus 400. A determiner signal 411 and a deter miner signal 413 are provided by the determiner 403. A converter signal 415 is provided by the converter 401.

The audio signal processing apparatus 400 is configured to adaptively add synthetic binaural cues to the audio signal without manual intervention by the listener 101.

The converter 401 is configured to convert a stereo audio signal, for example the input audio signal 407, into a binaural audio signal and output it as converter signal 415.

The determiner 403 is configured to determine upon the basis of the indicator signal 405 whether the input audio signal 407 is a stereo audio signal or a binaural audio signal. The determiner 403 is further configured to provide the input audio signal 407 to the converter 401 if the input audio signal 407 is a stereo audio signal.

The indicator signal 405 indicates whether the input audio signal 407 is a stereo audio signal or a binaural audio signal.

The input audio signal 407 can be a stereo audio signal or a binaural audio signal. Furthermore, the input audio signal 407 can be a two-channel audio signal or a parametric audio signal.

The output audio signal 409 can be a stereo audio signal or a binaural audio signal. Furthermore, the output audio signal 409 can be a two-channel audio signal or a parametric audio signal.

The determiner signal 411 comprises the input audio signal 407 in case the determiner 403 determines that the input audio signal 407 is a binaural audio signal. In this case, the input audio signal 407 is directly provided as output audio signal 409.

The determiner signal 413 comprises the input audio signal 407 in case the determiner 403 determines that the input audio signal 407 is a stereo audio signal. In this case, the determiner signal 413 is provided to the converter 401 in order to add synthetic binaural cues to the stereo audio signal.

The converter signal 415 comprises the stereo audio signal with added synthetic binaural cues and is provided as output audio signal 409.

In an implementation form, the determiner 403 comprises a receiver or a receiving unit for receiving the indicator signal 405 to determine whether the audio scene is immersive.

In an implementation form, the indicator signal 405 is obtained from external sources such as a content provider or from a previous analysis of the audio signal. The indicator signal 405 can be stored and transmitted as metadata (tag) in existing metadata containers.

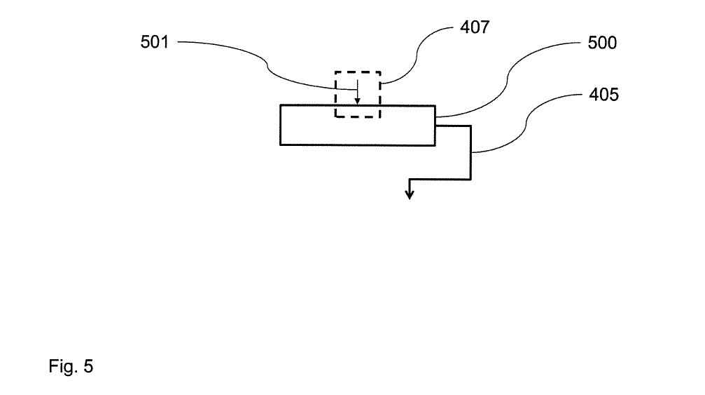

In an implementation form, the indicator signal 405 is not obtained by analyzing the input signal but provided together with the audio signal 407 as side information 405. Different scenarios can be possible for obtaining the indicator signal 405. For example, the indicator signal 405 can be fixed during the production process of the signal and provided in the form of metadata describing the content of the signal analogous to e.g. artist and title information. This can allow the content producer to indicate the best processing for the signal. Also, the indicator signal 405 can be obtained automatically by a previous analysis of the audio signal 407 as will be explained later in more detail, for example based on FIGS. 5 to 7.

In an implementation form, given an input audio signal 407 and an indicator signal 405, a determiner 403 adopts the processing to the signal based on the indicator signal 405 as follows. In case the acoustic scene of the input audio signal 407 is immersive, the original binaural cues and the original acoustic scene can be preserved. In case the acoustic scene of the input audio signal 407 is not immersive, a stereo widening technique can be applied which results in the perception of a wider stereo stage or out-of-head localization. An output audio signal 409 can be returned which can create an immersive listening experience.

In an implementation form, the indicator signal 405 is transmitted along with the audio signal as accompanying side information (metadata) and used for adapting the processing.

FIG. 5 shows a schematic diagram of an analyzer 500 for a two-channel input audio signal 501. The two-channel input audio signal 501 is an implementation form of the input audio signal 407. The analyzer 500 is configured to provide an indicator signal 405.

The analyzer 500 can be configured to analyze the two-channel input audio signal 501 to generate the indicator signal 405 indicating whether the two-channel input audio signal 501 is a stereo audio signal or a binaural audio signal. The analyzer 500 can further be configured to extract localization cues from the two-channel input audio signal 501, wherein the localization cues can indicate a location of an audio source. Moreover, the analyzer 500 can be configured to analyze the localization cues in order to generate the indicator signal 405.

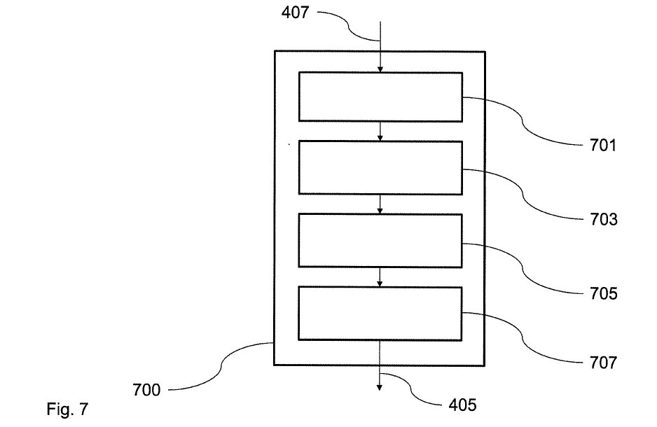

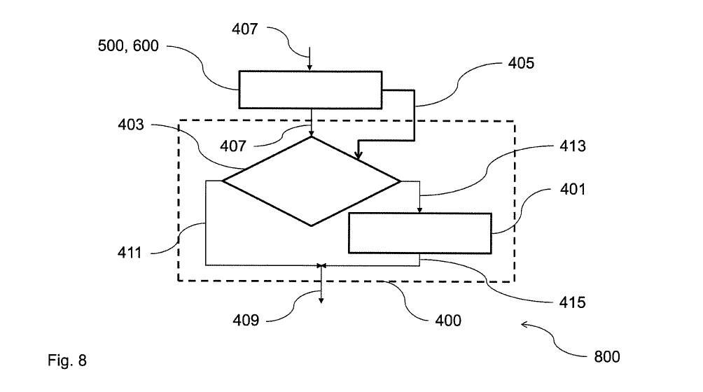

The two-channel input audio signal 501 can comprise a first audio channel signal and a second audio channel signal. The two-channel input audio signal 501 can be a stereo audio signal or a binaural audio signal. The two-channel input audio signal 501 corresponds to the input audio signal 407 of FIG. 4, FIG. 7 and FIG. 8.

In an implementation form, the indicator signal 405 is stored and/or transmitted along with the audio signal as a specific indicator (e.g. a flag), in order not to analyze the same input audio signal multiple times.

In an implementation form, given the two-channel input audio signal 501, the signal is analyzed in the analyzer 500 in order to decide whether the acoustic scene of the signal creates an immersive listening experience or not. The result of the analysis can be provided in the form of the indicator signal 405 that indicates whether the acoustic scene is immersive. The indicator signal 405 can optionally be stored and/or transmitted in the form of a new tag in an existing metadata container such as ID3v1, ID3v2, APEv1, APEv2, CD-Text, or Vorbis comment.

In an implementation form, the two-channel input audio signal 501 is analyzed with respect to its immersiveness and the result is provided in the form of the indicator signal 405. The indicator signal 405 can be stored and/or transmitted along with the signal as accompanying side information (metadata).

In an implementation form, the analyzer 500 is adapted to determine, whether the two-channel input audio signal 501 is a binaural audio signal or not.

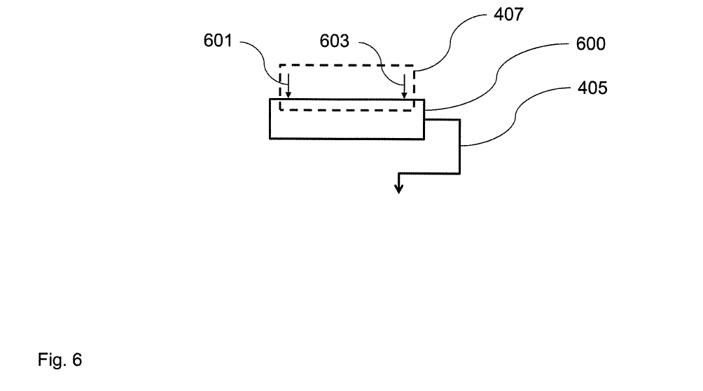

FIG. 6 shows a schematic diagram of an analyzer 600 for a parametric input audio signal. The parametric input audio signal is an implementation form of the input audio signal 407. The parametric input audio signal comprises a down-mix input audio signal 601 and parametric side information 603. The analyzer 600 is configured to provide an indicator signal 405.

The analyzer 600 can be configured to analyze the parametric audio input signal to generate the indicator signal 405 indicating whether the parametric audio input signal is a stereo audio signal or a binaural audio signal. The analyzer 600 can further be configured to extract localization cues from the parametric audio input signal, wherein the localization cues can indicate a location of an audio source. Moreover, the analyzer 600 can be configured to analyze the localization cues in order to generate the indicator signal 405.

The parametric audio input signal can be a stereo audio signal or a binaural audio signal. The parametric audio input signal corresponds to the input audio signal 407 of FIG. 4, FIG. 7 and FIG. 8.

The down-mix input audio signal 601 can be obtained by down-mixing a two-channel audio signal to a single channel or mono audio signal.

The parametric side information 603 can correspond to the down-mix input audio signal 601 and can comprise localization cues or spatial cues.

In an implementation form, the analyzer 600 is configured to extract and analyze the parametric side information 603 to generate the indicator signal 405.

In an implementation form, the input audio signal is given in form of an encoded representation as a parametric signal comprising a single channel or mono down-mix of a two-channel signal with accompanying side information comprising spatial cues.

In an implementation form, the input audio signal does not comprise a two-channel audio signal but is given in form of an encoded representation as a parametric audio signal comprising a single channel down-mix of a two-channel signal with accompanying side information comprising spatial cues. The analysis results can be based on the spatial cues given explicitly in the side information.

FIG. 7 shows a schematic diagram of an analyzing method 700. The analyzing method comprises an extraction 701, an analysis 703, a determination 705 and a generation 707. The analyzing method 700 is configured to analyze an input audio signal 407 in order to provide an indicator signal 405.

The indicator signal 405 can indicate whether the input audio signal 407 is a stereo audio signal or a binaural audio signal.

The input audio signal 407 can comprise a two-channel input audio signal 501 or a parametric input audio signal, which can comprise a down-mix input audio signal 601 and parametric side information 603.

The analyzing method 700 is configured to analyze the input audio signal 407 in order to generate the indicator signal 405, which indicates whether the input audio signal 407 is a stereo audio signal or a binaural audio signal.

The extraction 701 comprises an extraction of localization cues from the input audio signal 407. In an implementation form, the extraction 701 comprises an extraction of binaural cues, such as an interchannel-time-difference (ITD) and/or and interchannel-level-difference (ILD).

The analysis 703 comprises an analysis of the localization cues provided by the extraction 701. In an implementation form, the analysis 703 comprises an analysis of binaural cues to estimate the acoustic scene, e.g. the position of sources.

The determination 705 comprises a determination of an immersiveness of the acoustic scene based on the analysis results of the analysis 703. In an implementation form, the determination 705 comprises a statistical analysis of source positions to measure how immersive the acoustic scene is.

The generation 707 comprises a generation or creation of the indicator signal 405 based on the determination results of the determination 705. In an implementation form, the generation 707 is based on a decision whether the acoustic scene is to be considered immersive or not.

In an implementation form, the analyzing method 700 analyzes the input audio signal 407 in order to decide whether stereo widening is appropriate for the signal in order to enhance the listening experience. To this end, spatial properties of the acoustic scene can be estimated and evaluated with respect to perceptual properties. A main goal can be to detect whether an audio signal was recorded using a dummy head, or not.

In an implementation form, given an input audio signal 407, in the extraction 701, localization cues are extracted. Then, in the analysis 703, the localization cues are analyzed with respect to perceptual criteria. In the determination 705, the immersiveness of the scene is determined and finally, in the generation 707, the indicator signal 405 is generated.

In an implementation form, the analyzing method 700 is applied to a two-channel input audio signal 501 as well as to a parametric input audio signal comprising a down-mix input audio signal 601 and parametric side information 603.

In an implementation form, different analyzing strategies are possible, each addressing one key difference between stereo audio signals and binaural audio signals. In particular, contrary to stereo audio signals, binaural audio signals can exhibit the following properties: interchannel-time- and level-differences which can correspond to sound sources outside of the loudspeaker span of 30 degrees; and consistency of simultaneous localization cues with respect to each other as well as model assumptions which can take the auditory system and the shape of the human body, e.g. head, pinnae and/or torso, into account.

In an implementation form, the extraction 701 is realized as follows. The localization cues can be extracted from the audio signals using appropriate signal processing methods, as described e.g. in C. Faller, F. Baumgarte, “Binaural Cue Coding—Part II: Schemes and Applications,” IEEE Transactions On Speech and Audio Processing, Vol. 11, No. 6, 2003. The analysis can be performed in a frequency selective manner using a kind of sub-band decomposition as a preprocessing step. Then, a combination or subset of the following cues can be derived: interchannel-level-differences can be measured by analyzing the signal's energy, amplitude, power, loudness, or intensity; interchannel-time differences or interchannel-phase differences can be measured by analyzing phase delays, group delays, interchannel-correlation, and/or differences in time of arrival; and spectral shape matching can be used to detect spectral differences between the channels which can result from different location-dependent reflections at the pinnae.

In an implementation form, the analysis 703 is realized as follows. The localization cues can be analyzed with respect to perceptual criteria. In order to decide whether the audio signal provides an immersive listening experience, the spatial cues or localization cues can be analyzed according to one or several of the following characteristics.

As a first possible characteristic the positions of sources can be analyzed. Using the localization cues, it is possible to determine individual audio sources and their relative position within the audio signal. Typical approaches can use interchannel-time- or level-differences, as described e.g. in Heckmann et al., Modeling the Precedence Effect for Binaural Sound Source Localization in Noisy and Echoic Environments, Interspeech 2006, a model of pinnae reflections, as described e.g. in Ichikawa, O; Takiguchi, T.; Nishimura, M.; Source Localization Using a Pinna-Based Profile Fitting Method, IWAENC, 2003, combinations thereof, as described e.g. in Gaik, W.; Combined evaluation of interaural time and intensity differences: psychoacoustic results and computer modeling, JASA 94(1):98-110, 1993 or even full HRTFs, as described e.g. in Keyrouz, F; Naous, Y.; Diepold, K., A New Method For Binaural 3-D Localization Based on HRTFs, ICASSP 2006.

As a second possible characteristic the consistency can be analyzed. A further indicator that a signal was recorded using a dummy head creating natural binaural cues can be the consistency of localization cues. The consistency can relate to left/right consistency as follows. In binaural recordings, monaural localization cues which can be independently obtained for both channels, e.g. spectral shapes resulting from pinnae reflections, can match between the two ears, i.e. they are consistent for an individual sound source. For stereo recordings, they are not necessarily. The consistency can also relate to inter-cue consistency as follows. In stereo recordings, the sources can be manually panned to a certain position in the space. As a result of this manual interaction, the localization cues may not be consistent. For example, for one source, the interchannel-time-differences may not match the inter-channel-level-differences. The consistency can also relate to a consistency with a model of perception as follows. Natural localization cues of high perceptual relevance may not only depend on the distance between the two microphones, but also on the characteristic shape of the human head and torso as well as the pinnae. Amplitude and delay added manually in the production process of stereo signals may not take these characteristics into account. For example, as a result of natural shadowing by the human head, inter-channel-level differences of binaural signals recorded using a dummy head can show a strong dependency on frequency. For low frequencies, the human head can be small in comparison to the wavelength and ILDs are low. For high-frequencies, the head can be large resulting in a high shadowing and large ILD values. A signal exhibiting such frequency dependent ILDs can be considered to be recorded using a dummy head. Also, characteristic frequency dependence for certain source positions can be expected according to the characteristic shape of the pinnae.

As a third possible characteristic further criteria can be considered. Further criteria such as the interchannel-coherence or cross-correlation can be used to evaluate the immersiveness of an audio signal, as described e.g. in C. Faller, F. Baumgarte, “Binaural Cue Coding—Part II: Schemes and Applications,” IEEE Transactions on Speech and Audio Processing, Vol. 11, No. 6, 2003.

In an implementation form, the determination 705 is realized as follows. The immersiveness of the signal can be determined. For this purpose, all the aforementioned criteria can be used to obtain a measure of the immersiveness of the signal. For example, for a scene which contains a large amount of sources with consistent and perceptually relevant localization cues which are placed outside of the line segment between two loudspeakers and/or headphones, a processing which further widens the stereo base may not be beneficial. The source position criteria can be combined with consistency criteria or measures. The consistency of localization cues can be very important for the perception. For more consistent localization cues, the perception can be more natural and the scene can be perceived more immersive.

In an implementation form, the generation 707 is realized as follows. Based on the analysis according to any of the aforementioned criteria, the indicator signal 405 can be generated indicating whether stereo widening techniques should be applied to the stereo audio signal in order to enhance the listening experience.

Four alternative implementation forms for the analyzing method 700 are given below in the order of increasing complexity.

In an implementation form, the analyzing method 700 comprises analyzing the degree of similarity of the audio channels. The localization cues can comprise an interchannel-coherence (IC) measure describing the degree of similarity, e.g. the amount of correlation, of the audio channels of the audio signal with a value between 0 and 1. The IC measure can be analyzed to obtain the side information signal. The lower the IC, the larger the perceived width and the more likely the audio signal is a binaural audio signal and the less it can benefit from a stereo widening. This can be implemented using a threshold based decision.

Thus, an implementation form of the method 700 comprises for example: extracting IC values, e.g. a full-band, IC value or IC-values for one, some or all sub-bands, from the input audio signal 407; comparing the IC-values with a predetermined IC threshold value, and generating the indicator signal having a first value, which indicates that the audio signal is a binaural signal, in case, e.g. the full-band, IC value or the one IC-value or a subset of the some or all IC-values is smaller than the predetermined IC threshold value, and/or and generating the indicator signal having the second value, which indicates that the audio signal is a stereo signal, in case, e.g. the full-band, IC value or the one IC-value or a subset of the some or all IC-values is equal or larger than the predetermined IC threshold value.

In an implementation form, the analyzing method 700 comprises analyzing the position of sources. The localization cues can comprise measures of interchannel-time-differences, also in combination with interchannel-level-differences. A simple triangulation can lead to a measure of the direction of sound sources given in the form of an angle in degrees. An angle of 0 degrees can be assumed to be in the center, ±90° can be left or right. The more the angle of a sound source deviates from 0 degrees, the larger the perceived width and the more likely the signal may not benefit from a widening. This can be a simple threshold based decision. Typically, for stereo signals, sources can be assumed to be within a range ±45° or ±60°.

Thus, in an implementation form the method 700 comprises: extracting IC values like ITD and/or ILD values, e.g. a full-band, IC value or IC-values for one, some or all sub-bands, from the input audio signal 407; determining an angle for the full-band, IC value or angles for one, some or all sub-bands for comparing the angle with a predetermined threshold angle, e.g. ±45° or ±60°, and generating the indicator signal having a first value, which indicates that the audio signal is a binaural signal, in case, e.g. the full-band, IC angle or the one angle or a subset of the some or all angles is larger than the predetermined threshold angle, and/or and generating the indicator signal having the second value, which indicates that the audio signal is a stereo signal, in case, e.g. the full-band, IC angle or the one angle or a subset of the some or all angles is equal to or smaller than the predetermined threshold angle.

In an implementation form, the analyzing method 700 comprises analyzing the consistency of localization cues. The localization cues can comprise measures of interchannel-time-differences and interchannel-level-differences. The direction or angle of a sound source can be determined for interchannel-time-differences and interchannel-level-differences independently. For each source, two independent source angle estimates can be obtained. The absolute difference, e.g. in degrees, between both angle estimates can be determined. A difference larger than 10° or 20° can constitute an inconsistent localization result. A large number of inconsistent localization results can indicate that an audio signal is a stereo signal where the sources are manually panned. For binaural signals, the localization results can typically be consistent because they result from the description of a natural scene.

Thus, in an implementation form the method 700 comprises: extracting two types of IC values like ITD and ILD values, e.g. two full-band IC values or two IC-values for one, each of some or all sub-bands, from the input audio signal 407; determining angles for the two full-band, IC values or two angles for each of one, some or all sub-bands for comparing the angle for the first IC type with the angle for the second IC type, and comparing the difference between the angles with a predetermined threshold difference angle, e.g. ±10° or ±20°, and generating the indicator signal having a first value, which indicates that the audio signal is a binaural signal, in case, e.g. the full-band angle difference or the angle difference of the one or a subset of the some or all difference angles is smaller than the predetermined threshold angle, and/or and generating the indicator signal having the second value, which indicates that the audio signal is a stereo signal, in case, e.g. the full-band angle difference or the angle difference of the one or a subset of the some or all difference angles is equal or larger than the predetermined threshold angle.

In an implementation form, the analyzing method 700 comprises HRTF matching. The localization cues can be encoded using Head-related-transfer-functions (HRTFs). Head-related-transfer-functions (HRTFs) can capture the entire set of localization cues for a given source angle. The complete set of localization cues might be present in binaural audio signals but is not in stereo audio signals. When recording a binaural audio signal using a dummy head, the signal emitted by a source can be filtered by the pair of left ear and/or right ear HRTFs corresponding to the angle of the source to obtain the binaural audio signal. As a result, inverse filtering a binaural audio signal with the pair of left and/or right HRTFs corresponding to the source angle, the original signals for both channels can be obtained. In the case of a binaural audio signal, the two signals can be close to identical. In an implementation form, the HRTF matching is implemented as follows. A set of pairs of left and/or right ear HRTFs for all possible source angles can be given. Inverse filtering of the signal with each pair and computing the correlation between the resulting left and/or right signal can be performed. The pair resulting in maximum correlation can define the position and/or angle of the source. The corresponding value, between 0 and 1, of the correlation can indicate a degree of consistency for the localization cues in the signal. A high value can indicate that the audio signal is a binaural signal, a low value can indicate that the audio signal is a stereo signal. This procedure is typically the most accurate procedure, but also computationally more expensive.

FIG. 8 shows a schematic diagram of an audio signal processing system 800. The audio signal processing system 800 comprises an audio signal processing apparatus 400, as exemplarily described based on FIG. 4, and an analyzer 500, 600, as exemplarily described based on FIGS. 5 and 6.

The audio signal processing apparatus 400 comprises a converter 401 and a determiner 403. An indicator signal 405 and an input audio signal 407 are provided to the determiner 403. An output audio signal 409 is provided by the audio signal processing apparatus 400. A determiner signal 411 and a determiner signal 413 are provided by the determiner 403. A converter signal 415 is provided by the converter 401.

The analyzer 500, 600 is configured to analyze the input audio signal 407 to generate the indicator signal 405 indicating whether the input audio signal 407 is a stereo audio signal or a binaural audio signal. The analyzer 500, 600 is further configured to extract localization cues from the input audio signal 407, wherein the localization cues indicate a location of an audio source. Moreover, the analyzer 500, 600 is configured to analyze the localization cues in order to generate the indicator signal 405.

In this implementation form, the analyzer 500, 600 is further configured to provide the input audio signal 407 at an output port of the analyzer 500, 600 to the determiner 403.

In an implementation form, the audio signal processing system 800 realizes a fully automated system for adapting the processing of an input audio signal 407 according to the signal's content.

In an implementation form, the audio signal processing system 800 realizes a fully automated content-based adaption of an input audio signal 407. This system can be implemented in smartphones, MP3-players, and PC soundcards in order to provide an immersive listening experience without any kind of manual interaction by the listener. The system can receive an input audio signal 407 and outputs an output audio signal 409 that creates an immersive listening experience. In particular, the system can automatically decide whether synthetic binaural cues should be added to enhance the width of a stereo signal or to preserve the original binaural cues of the input audio signal 407. The decision can be based on a content-based analysis of the input audio signal 407.

In an implementation form, given an input audio signal 407, the signal is analyzed in the analyzer 500, 600 in order to decide whether the acoustic scene of the signal creates an immersive listening experience or not. The result of the analysis can be provided in the form of the indicator signal 405 that indicates whether the acoustic scene is immersive. Based on the indicator signal 405, the determiner 403 can adopt the processing to the signal. In case the acoustic scene of the input audio signal 407 is immersive, the original binaural cues and the original acoustic scene can be preserved. In case the acoustic scene of the input audio signal 407 is not immersive, a stereo widening technique is applied to create the perception of a wider stereo stage and/or out-of-head localization. The output audio signal 409 is returned to create an immersive listening experience.

In an implementation form, the processing of the input audio signal 407 is adopted fully automatically according to the signal's content. No manual interaction can be required.

In an implementation form, the analyzer 500, 600 is adapted to determine, whether the input audio signal 407 is a binaural audio signal or not.

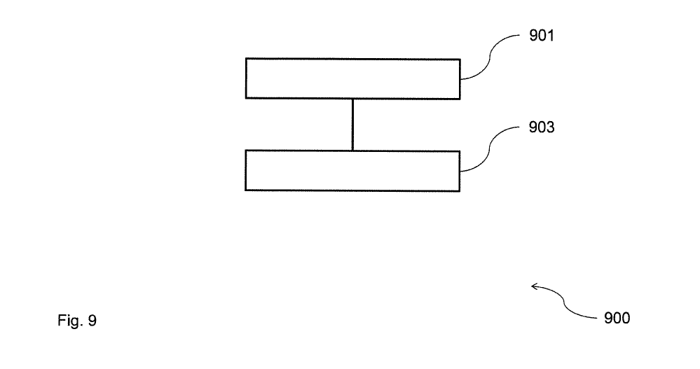

FIG. 9 shows a schematic diagram of a method 900 for processing an audio signal. The method 900 comprises determining 901 upon the basis of an indicator signal 405 whether the audio signal is a stereo audio signal or a binaural audio signal, the indicator signal 405 indicating whether the audio signal is a stereo audio signal or a binaural audio signal. The method 900 further comprises converting 903 the stereo audio signal into a binaural audio signal if the audio signal is a stereo audio signal.

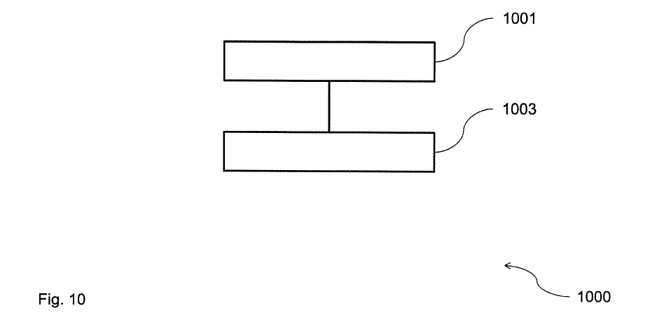

FIG. 10 shows a schematic diagram of a method 1000 for analyzing an audio signal. The method 1000 is configured for analyzing the audio signal to generate an indicator signal 405 indicating whether the audio signal is a stereo audio signal or a binaural audio signal. The method 1000 comprises extracting 1001 localization cues from the audio signal, the localization cues indicating a location of an audio source. The method 1000 further comprises analyzing 1003 the localization cues in order to generate the indicator signal 405.

In an implementation form, the method 1000 for analyzing an audio signal comprises the analyzing method 700.

The abovementioned implementation forms of the invention, e.g. the analyzer, determiner, storing and transmission of the analysis results, can be adopted in a number of different possible embodiments. These embodiments can aim at different scenarios and can provide an immersive listening experience without requiring any kind of manual interaction by the listener in all considered scenarios.

The human auditory system can use several cues for localizing sound sources as described e.g. in Blauert, J.; Spatial Hearing: The Psychophysics of Human Sound Localization, MIT Press, Cambridge, Mass., 1997. The transfer function between a sound source with a specific position in space and a human ear can be called head-related-transfer function (HRTF). Such HRTFs can capture localization cues such as interaural-time-differences (ITD), interaural-level-differences (ILD), direction-selective frequency filtering of the outer ear, direction-selective reflections at the head, shoulders and body, and environmental cues.

Interaural-time-differences (ITD) can be characterized as follows. As a result of differences in distance, there can be a time delay between signals arriving at the two ears. Depending on frequency, this delay can be measured as phase delay, group delay, and/or differences in time of arrival and allows for differentiating left and/or right. Interaural-level-differences (ILD) can be characterized as follows. As a result of head shadowing, level differences between the two ears can appear. This effect can be more pronounced for higher frequencies and can allow for differentiating left and/or right. Direction-selective frequency filtering of the outer ear can be characterized as follows. The human ear (pinnae) can have a characteristic shape which can impose direction-specific patterns onto the frequency response and can allow for differentiating front and/or back and above and/or below. Direction-selective reflections at the head, shoulders and body can be characterized as follows. Characteristic reflections at the human body can be detected and evaluated by the human auditory system. Environmental cues can be characterized as follows. Properties of the environment can be taken into account in order to evaluate the distance of a sound source, such as room reflections and reverberation, loudness and the fact that high frequencies can be damped stronger in air than low frequencies.

In real listening scenarios, a combination of these cues can be taken into account for localizing a sound source. The relevance of a perceived direction of a cue can depend on many parameters such as the frequency, the stability, and the consistency. Also, the first detected wave-front, which typically can have strong loudness, of a sound source can be more important for the direction perception than later arriving and weaker wave-fronts from different directions. This effect can relate to the Haas or precedence effect, wherein the direction can be determined largely by the localization cues from the initial onset of the sound, as described e.g. in Gardner, M. B; Historical Background of the Haas and/or Precedence Effect, JASA, 1968.

In an implementation form, the invention relates to a method to adaptively process audio signals where the decision for the adaptation is based on an indicator signal comprising means of receiving an audio signal, means of receiving an indicator signal, and adjusting the audio signal depending on the indicator signal.

In an implementation form, the invention further relates to a method according to the previous implementation form where the indicator signal is obtained from an analyzer and the decision is based on the analysis result comprising means of detecting localization cues in audio recordings, means of analyzing the localization cues with respect to perceptual properties of the acoustic scene, and creating an indicator signal based on the analysis result.

In an implementation form, the invention further relates to a method according to the previous implementation form where the analysis result is stored and transmitted as an indicator signal.

In an implementation form, the invention further relates to a method according to one of the preceding implementation forms where the input audio signal consists of a single-channel audio signal with accompanying side information comprising spatial cues, i.e. parametric audio.

In an implementation form, the invention relates to a method and an apparatus for adaptively processing audio signals.

In an implementation form, the audio signal processing apparatus comprises an analyzer which extracts binaural cues from the audio signal and analyzes the acoustic scene as well as a determiner which determines whether stereo widening should be applied on the basis of the analysis result.

In an implementation form, the analysis result is stored and transmitted in the form of an indicator signal.

In an implementation form, the determination of the determiner is based on the indicator signal. Therefore, the invention can facilitate an automatic adaption of audio recordings in order to create an immersive listening experience without any manual interaction by the listener.

In an implementation form, an immersive acoustic scene is characterized by audio sources surrounding the listener.

In an implementation form, binaural cues are extracted from the audio signal in order to determine the positions of all acoustic sources in the audio signal. This can result in a description of the acoustic scene.

In an implementation form, statistical and/or psychoacoustic properties of the acoustic scene are analyzed to evaluate how immersive the perception is. For example, a scene which contains a large amount of consistent sources which are placed outside of the line segment between the two loudspeakers and/or headphones can create an immersive listening experience.

In an implementation form, the audio signal is analyzed to determine whether the acoustic scene creates an immersive perception.

In an implementation form, the invention relates to a method for adaptive audio signal processing with an analyzer and determiner where the determination is based on the analysis result, e.g. by an encoder and/or decoder comprising means of detecting binaural localization cues in audio recordings, means of analyzing the localization cues with respect to properties of the acoustic scene and means of adjusting the audio signal depending on properties of the acoustic scene.

In an implementation form, the invention relates to a method for adaptive audio signal processing with an analyzer and determiner, where the analysis result is stored and transmitted as an indicator signal.

In an implementation form, the invention relates to a method for adaptive audio signal processing with a receiver and/or determiner where the determination is based on an indicator signal.

In an implementation form, the invention relates to a content-based analyzer/determiner which is used to facilitate adaptive adjustment of audio recordings.

In an implementation form, the invention is applied for sound presentation using loudspeakers or headphones, as in mobile and home HIFI, cinema, video games, MP3 Players, and teleconferencing applications.

In an implementation form, the invention is applied for adaptation of rendering to terminal constraints in audio systems.

What is claimed is:

1. An audio signal processing apparatus for processing an audio signal, the audio signal processing apparatus comprising:
a converter configured to convert a stereo audio signal into a binaural audio signal; and
a determiner configured to determine upon the basis of an indicator signal whether the audio signal is a stereo audio signal or a binaural audio signal, the indicator signal indicating whether the audio signal is a stereo audio signal or a binaural audio signal, the determiner being further configured to provide the audio signal to the converter if the audio signal is a stereo audio signal.

2. The audio signal processing apparatus of claim 1, comprising:
an output terminal for outputting the binaural audio signal, and wherein the determiner is configured to directly provide the audio signal to the output terminal if the audio signal is a binaural audio signal.

3. The audio signal processing apparatus of claim 1, further comprising:
an analyzer for analyzing the audio signal to generate the indicator signal.

4. The audio signal processing apparatus of claim 3, wherein the analyzer is configured to extract localization cues from the audio signal, the localization cues indicating a location of an audio source, and to analyze the localization cues in order to generate the indicator signal.

5. The audio signal processing apparatus of claim 1, wherein the converter is configured to add synthetic binaural cues to the stereo audio signal to obtain the binaural audio signal.

6. The audio signal processing apparatus of claim 1, wherein the audio signal is a two-channel audio signal comprising a first audio channel signal and a second audio channel signal, wherein the analyzer is configured to determine an immersiveness measure based on an interchannel-coherence or an interchannel-time-difference or an interchannel-phase-difference or an interchannel-level-difference or combinations thereof between the first audio channel signal and the second audio channel signal, and to analyze the immersiveness measure to generate the indicator signal.

7. The audio signal processing apparatus of claim 1, wherein:
the audio signal is a two-channel audio signal comprising a first audio channel signal and a second audio channel signal; and
the analyzer is configured to determine a number of first original signals and a number of second original signals for the first audio channel signal and the second audio channel signal by means of inverse filtering by a number of head-related-transfer-function pairs and to analyze the number of first original signals and the number of second original signals to generate the indicator signal.

8. The audio signal processing apparatus of claim 1, wherein the audio signal is a parametric audio signal comprising a down-mix audio signal and parametric side information, wherein the analyzer is configured to extract and analyze the parametric side information to generate the indicator signal.

9. The audio signal processing apparatus of claim 1, wherein the determiner is configured to determine that the audio signal is a stereo audio signal if the indicator signal comprises a first signal value and/or to determine that the audio signal is a binaural audio signal if the indicator signal comprises a second signal value.

10. The audio signal processing apparatus of claim 1, wherein the indicator signal is a part of the audio signal and wherein the determiner is configured to extract the indicator signal from the audio signal.

11. An analyzer for analyzing an audio signal to generate an indicator signal indicating whether the audio signal is a stereo audio signal or a binaural audio signal, the analyzer configured to:
extract localization cues from the audio signal, the localization cues indicating a location of an audio source; and
analyze the localization cues in order to generate the indicator signal.

12. A method for processing an audio signal, the method comprising:
determining upon the basis of an indicator signal whether the audio signal is a stereo audio signal or a binaural audio signal, the indicator signal indicating whether the audio signal is a stereo audio signal or a binaural audio signal; and
converting the stereo audio signal into a binaural audio signal if the audio signal is a stereo audio signal.

13. The method of claim 12, further comprising:
extracting the indicator signal from the audio signal.

14. A method for analyzing an audio signal to generate an indicator signal indicating whether the audio signal is a stereo audio signal or a binaural audio signal, the method comprising:
extracting localization cues from the audio signal, the localization cues indicating a location of an audio source; and
analyzing the localization cues in order to generate the indicator signal.

15. An audio signal processing system, comprising:
an audio signal processing apparatus, comprising:
a converter configured to convert a stereo audio signal into a binaural audio signal, and
a determiner configured to determine upon the basis of an indicator signal whether the audio signal is a stereo audio signal or a binaural audio signal, the indicator signal indicating whether the audio signal is a stereo audio signal or a binaural audio signal, the determiner being further configured to provide the audio signal to the converter if the audio signal is a stereo audio signal; and
an analyzer for analyzing the audio signal to generate an indicator signal indicating whether the audio signal is a stereo audio signal or a binaural audio signal, the analyzer configured to:
extract localization cues from the audio signal, the localization cues indicating a location of an audio source, and
analyze the localization cues in order to generate the indicator signal.

16. A non-transitory computer readable storage medium, comprising computer program code, which, when executed by a computer unit, causes the computer unit to:
determine upon the basis of an indicator signal whether the audio signal is a stereo audio signal or a binaural audio signal, the indicator signal indicating whether the audio signal is a stereo audio signal or a binaural audio signal; and
convert the stereo audio signal into a binaural audio signal if the audio signal is a stereo audio signal.

17. The non-transitory computer readable storage medium according to claim 16, wherein the computer program code further causes the computer unit to:
extract the indicator signal from the audio signal.

18. A non-transitory computer readable storage medium, tangibly embodying computer program code, which, when executed by a computer unit, causes the computer unit to:
analyze an audio signal to generate an indicator signal indicating whether the audio signal is a stereo audio signal or a binaural audio signal, comprising,
extract localization cues from the audio signal, the localization cues indicating a location of an audio source; and
analyze the localization cues in order to generate the indicator signal.
